(19) United States
(12) Patent Application Publication
(10) Pub. No.: US 2022/0144050 A1
(43) Pub. Date: May 12, 2022

(54) Rear Window Protection for Truck

(71) Applicant: Tailai Ting, Pomona, CA (US)

(72) Inventor: Tailai Ting, Pomona, CA (US)

(21) Appl. No.: 17/094,534

(22) Filed: Nov. 10, 2020

(51) Int. Cl. B60J 1/20

(52) U.S. Cl. CPC B60J 1/2094

(57) ABSTRACT

A rear window protector for truck includes a mesh netting window protector for prevention of the contact between the truck rear window and large object or debris in the truck bed. The rear window protector is installed on the truck rack with four extendable tubes and four clamps for easy installation with no drilling required. The placement of the window protector is adjustable and it can be installed on the curved position of truck racks.

### NOTICE OF COPYRIGHT

A portion of the disclosure of this patent document contains material which is subject to copyright protection. The copy right owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to functional rear window protectors for rack equipped trucks. More particularly, the inventive rear window protector includes tour bendable clamps and four extendable tubes for easy installations and adjustments.

### Description of Related Arts

Rear window protectors for commercial or personal use pickup trucks are well known. Often they are also referred to as “headache racks”, carrier racks, screen protector, cab guards and vehicle safety protectors. Most rear window protectors provide dual protections, protection from large objects carried in the truck bed and protection from debris.

Currently on the market, most window protectors arc installed directly onto the truck bed and working independently as window protectors. People installing such window protectors on their trucks are not able to install truck racks to carry large objects such as ladders, lumbers, or cargos. The other kind of window protector people can choose from the market are the ones for rack equipped trucks. Those window protectors require the truck to have racks then they can be installed on those racks. And such window protectors can only be installed on where the vertical pole is up straight with no curves. However, most truck rack on the market come with curved vertical poles. To install the window protectors while avoiding the curved part on the vertical pole is difficult and make it sometimes installed on improper position. So the window protector won't provide adequate protection. Also, the installations of such window protectors require drilling holes, so the window protectors are often designed to only fit on certain truck racks. None of the above window protectors provide universal fitment to all kinds of truck racks and allow for easy installation and adjustment while it can also be installed on any part of the truck racks even on the curves of the poles.

### SUMMARY OF THE PRESENT INVENTION

A main object of the present invention is to provide a rear window protector with universal fitment, wherein the user can install it on various truck racks.

Another advantage of the present invention is to provide a rear window protector, wherein the user can install it on the curved position of truck racks' vertical poles.

Another advantage of the invention is to provide a rear window protector, wherein the user only needs wrenches to secure bolts and nuts instead of drilling.

Another advantage of the invention is to provide a rear window protector, wherein the user can adjust the placement of the protector with four bendable clamps.

Another advantage of the invention is to provide a rear window protector, wherein the user can adjust the placement of the protector with tour extendable tubes to fit track beds of different widths.

Another advantage of the invention is to provide a rear window protector, wherein the user still has space to install truck rack to cam large objects such as ladders, lumbers, or cargos.

Additional advantages and features of the invention will become apparent from the description which follows, and may be realized by means of the instrumentalities and combinations particular point out in the appended claims.

### BRIEF DESCRIPTION OH THE DRAWINGS

FIG. 1 is a perspective view of the rear window protector in the preferred embodiment of the present invention according to the present invention.

FIG. 2 is a perspective view of the rear window protector in the preferred embodiment of the present invention, showing how the extendable tubes are inserted into the window protector to be installed onto the truck rack.

FIG. 3 is a perspective view of the rear window protector in the preferred embodiment of the present invention, showing how the window protector was installed into the curved position of the truck rack's vertical pole with four clamps.

FIG. 4 is a perspective view of the rear window protector in the preferred embodiment of the present invention, showing how the clamps are secured on the truck rack with bolts and nuts.

FIG. 5 is a perspective view of the rear window protector in the preferred embodiment of the present invention, showing how the tubes are secured on tire upper and bottom part of the window protector to adjust it to a certain length.

### DETAILD DESCRIPTION OF THE INVENTION

The following description is disclosed to enable any person skilled in the art to make and use the present invention. Preferred embodiments arc provided in the following description only as examples and modifications will be apparent to those skilled in the art. The general principles defined in the following description in the following description would be applied to other embodiments, alternatives, modifications, equivalents, and applications without departing from the spirit and scope of the present invention.

According to the preferred embodiment, the rear window protector for a truck comprises one window protector, four steel tubes used to adjust the length of the protector to tit on truck beds of different widths, four clamps to connect the protector to the truck rack, and bolts and lock nuts to secure the tubes and clamps.

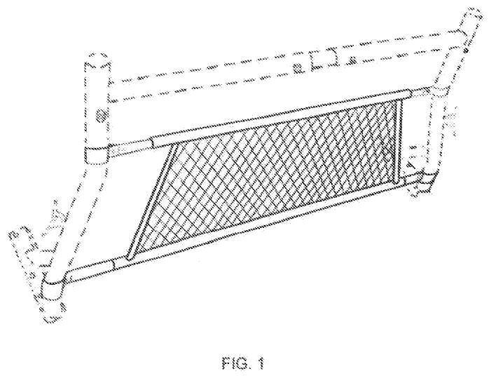

FIG. 1 is a perspective view of the rear window protector in the preferred embodiment of the present invention. The preferred embodiment of the present invention of a rear window protector further demonstrates that the protector is designed to be installed onto a rack equipped truck so it can be installed on the truck rack. The window protector is connected to the truck rack with four clamps.

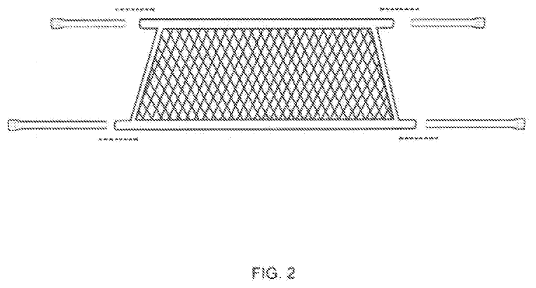

FIG. 2 is a perspective view of the rear window protector in the preferred embodiment of the present invention. The preferred embodiment of the present invention of a rear window protector further demonstrates that the four tubes can be inserted to the upper part and bottom part of the protector. The tubes can be secured at any location with lock nuts to make the upper part and the bottom part of the window protector to a certain length to tit truck beds of different widths.

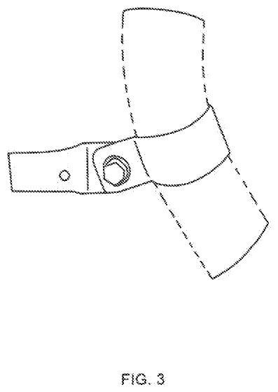

FIG. 3 is a perspective view of the rear window protector in the preferred embodiment of the present invention. The preferred embodiment of the present invention of a rear window protector further demonstrates that the rear window protector is connected to the truck rack with bendable clamps. The way to install the window protector with clamps allows the protector to be installed on the curved position of the track racks.

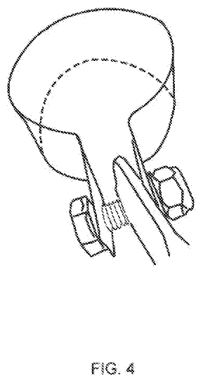

FIG. 4 is a perspective view of the rear window protector in the preferred embodiment of the present invention. The preferred embodiment of the present invention of a rear window protector further demonstrates the way how the bendable clamps are secured with bolts and nuts to allow for adjustments.

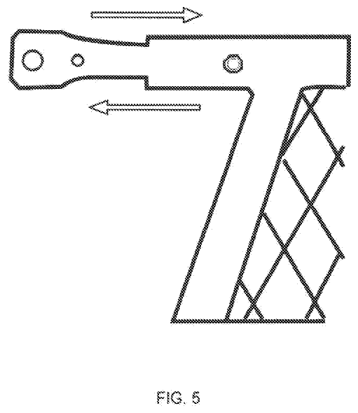

FIG. 5 is a perspective view of the rear window protector in the preferred embodiment oi the present invention. The preferred embodiment of the present invention of a rear window protector further demonstrates the extendable tubes arc secured with lock nuts on the upper and bottom part of the window protector to determine a certain length. The total length can be shortened by inserting the tubes deeper and it can be extended by pulling out the tubes to allow fitment on truck bens of different widths.

One skilled in the an will understand that the embodiment of the present invention as shown in the drawings and described above is exemplary only and not intended to be limiting.

It will thus be seen that the objects of the present invention have been fully and effectively accomplished. The embodiments have been shown and described tor the purposes of illustrating the functional and structural principles of the present invention and is subject to change without departure from such principles. Therefore, this invention includes all modifications encompassed within the spirit and scope of the following claims.

1. A rear window protector for trucks with truck racks installed on loading beds, comprising:
a metal mesh window protector: and
four extendable tubes to be inserted into the upper and bottom tubes of the window protector; and
four metal bendable clamps to connect the window protector to the truck racks; and
bolts and nuts to secure the tubes and clamps

2. The rear window protector, as recited in claim 1, wherein said window protector is adjustable in length with the extendable tubes to fit on truck racks of different widths.

3. The rear window protector as recited in claim 2, wherein said window protector can be installed on curved position of the truck racks with curved poles.

4. The rear window protector, as recited in claim 3, wherein said window protector is installed onto the truck racks with four bendable clamps.

5. The rear window protector, as recited in claim 4, wherein the position of said window protector is adjustable not only up and down but also back and forth for better compatibility.
